(19) United States
(12) Patent Application Publication
(10) Pub. No.: US 2007/0016930 A1
(43) Pub. Date: Jan. 18, 2007

(54) CREATION AND NAVIGATION OF MEDIA CONTENT WITH CHAPTERING ELEMENTS

(75) Inventors: Darren Wesemann, North Salt Lake, UT (US); Jeffrey Hays, Sandy, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Podfitness, Inc., Salt Lake City, UT (US)

(21) Appl. No.: 11/460,873

(22) Filed: Jul. 28, 2006

Related U.S. Application Data
(63) Continuation-in-part of application No. 11/074,879, filed on Mar. 8, 2005.
(63) Continuation-in-part of application No. 11/383,921, filed on May 17, 2006.
(60) Provisional application No. 60/682,361, filed on May 18, 2005.

(51) Int. Cl. H04N 5/445; G06F 3/00; G06F 13/00; H04N 7/10; H04N 7/025

(52) U.S. Cl. 725/46; 725/45; 725/34

(57) ABSTRACT

Generating navigable media content. A knowledge base stores content from multiple sources including subject matter experts. Specific content is identified from the knowledge base using attributes of a subscriber. The specific content corresponds to media clips that are mixed to generate individualized media content. The media content is then formatted with navigable elements that enable a user to navigate and perform the media content in a manner that is determined by the subscriber. The navigable elements may include chapter marks, or a menu that can be presented on the subscriber's device, for example.

### CROSS-REFERENCE TO RELATED APPLICATIONS

This application is a continuation-in-part of U.S. patent application Ser. No. 11/074,879 filed Mar. 8, 2005 and entitled METHOD AND SYSTEM FOR AUDIO PROGRAM CREATION AND ASSEMBLY. This application is also a continuation-in-part of U.S. patent application Ser. No. 11/383,921 filed May 17, 2006 and entitled MIXING AND PRODUCING INDIVIDUALIZED MEDIA FILES, which application claims the benefit of U.S. Provisional Patent Application Ser. No. 60/682,361 filed May 18, 2005. The foregoing applications are incorporated herein by reference in their entirety.

### BACKGROUND OF THE INVENTION

1. The Field of the Invention

The present invention relates to personalized media content. More particularly, embodiments of the invention relate to systems and methods for preparing individualized media content that is navigable.

2. The Relevant Technology

One of the best ways to achieve good results or to improve in a given subject or activity is to seek advice or suggestions from someone that is an expert in the relevant subject. One wanting to learn to cook, for example, would go to a cooking school for the best instruction. Anyone wanting a degree or to further their education would likely enroll in a class taught by a professor or a teacher. Similarly, those seeking to travel often consult travel guides or seek the advice of those that have traveled before. People starting a fitness regimen may seek the expertise of a fitness trainer.

The experience and expertise of a subject matter expert can help in a variety of ways. Subject matter experts, for example, often have the ability of being able to identify a preferred course of conduct or a preferred course of study. For example, personal trainers, who are experts in the subject of fitness, often have the ability to motivate their subscribers and to achieve better results than the subscriber could achieve on their own.

Unfortunately, seeking and obtaining the service of a subject matter expert can often prove difficult and expensive. For example, one wanting to achieve a fitness goal would probably seek a trainer, who is a subject matter expert in the subject of exercise or fitness. There are several reasons, however, that may prevent one from seeking the assistance of a personal trainer. The cost of personal trainers, the high demand for personal trainers, scheduling conflicts, travel issues, and the like are examples of reasons why a particular subscriber may not be able to find and benefit from the experience and expertise of a personal trainer. As a result, may subscribers are left without the support and instruction needed to achieve desired fitness goals.

Some people turn to mass media such as DVDs and videocassettes. These technologies, however, are not dynamic and cannot account for the differences that exists between different persons. Thus, the ability to bring the expertise of a subject matter expert in a dynamic way is lacking in existing technology and there is therefore a need to create instructions and personalized content in a portable medium to allow a subscriber to take a personalized media content with them in any location and for any subject. There is further a need to make the media able to dynamically adapt to a user's usage pattern.

### BRIEF SUMMARY OF THE INVENTION

These and other limitations are overcome by embodiments of the invention, which relates to systems and methods for generating individualized media content that can be navigated by the subscriber. This can be achieved by including navigable elements in the individualized media content.

In one embodiment, an expert system identifies specific content from a knowledge base. The specific content is associated with certain media clips. A mixer then mixes the identified media clips to produce the media content. Thus, the mixer combines multiple media clips that have been identified from the knowledge base according to attributes of a particular subscriber.

The mixing process can perform additional steps on the media content. In one embodiment, the media clips are from different sources and the mixer performs volume normalization. Advantageously, this prevents the media content from containing abrupt volume changes that may adversely require a user to continually adjust the volume. The mixing can also include standard clips that may or may not be dependent on the subscriber's attributes, such as rest clips.

After mixing the media content or during the mixing process, navigable elements are added to the media content. The navigable elements enable a subscriber to perform the media content in a manner that is determined by the subscriber. For example, a user can skip a portion of the media content, repeat a portion of the media content, and the like. The navigable elements may include chapter marks that can be used by the forward and reverse inputs of the subscriber's device. The navigable elements may also include a menu that can be navigated via the input mechanism of the subscriber's device.

After the media content is mixed and formatted, the navigable media content is transmitted to the subscriber. The subscriber can then provide input, which is then used to navigate the media content based on the input.

Additional features and advantages of the embodiments disclosed herein will be set forth in the description which follows, and in part will be obvious from the description, or may be learned by the practice of the invention. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1A illustrates one embodiment of an expert system for generating individualized media content for a subject;

FIG. 1B is an exemplary flow diagram for creating an expert system that delivers individualized media content;

FIG. 1C is an illustration of an expert system that uses a knowledge base to generate individualized media content for a subject;

FIG. 1D illustrates an embodiment of the common content and the SME data included in a knowledge base of an expert system;

FIG. 1E illustrates one embodiment of a user interface for providing attributes that define the philosophy of an SME;

FIG. 1F illustrates an exemplary method for determining an individualized sequence of methods for inclusion in individualized media content;

FIG. 2 illustrates an embodiment of individualized media content that has been generated for a subscriber;

FIG. 3 illustrates another embodiment of individualized media content where the subject of the media content is fitness;

FIG. 4 is a block diagram illustrating the generation of individualized media content for a subscriber; and

FIG. 5 is an exemplary flow diagram for generating individualized media content for a subscriber.

### DETAILED DESCRIPTION OF THE INVENTION

Embodiments of the invention relate generally to systems, methods, and/or computer program products for generating individualized media content. Embodiments of the invention further relate to an expert system that includes content that can be accessed searched, etc., in a manner that enables the expert system to generate individualized media content for individual subscribers. The content is typically related to a particular content and the media content generated by the expert system is related to the content. Because the expert system can individualize the media content, a user can continually progress in terms of receiving new content that reflects the user's experience, progress, wishes, and the like or any combination thereof.

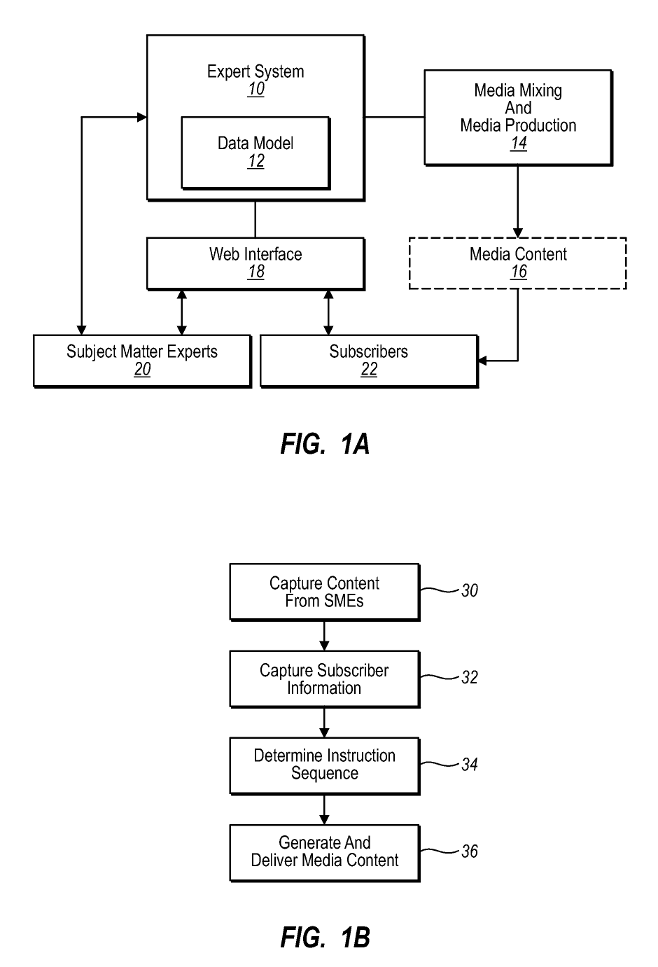

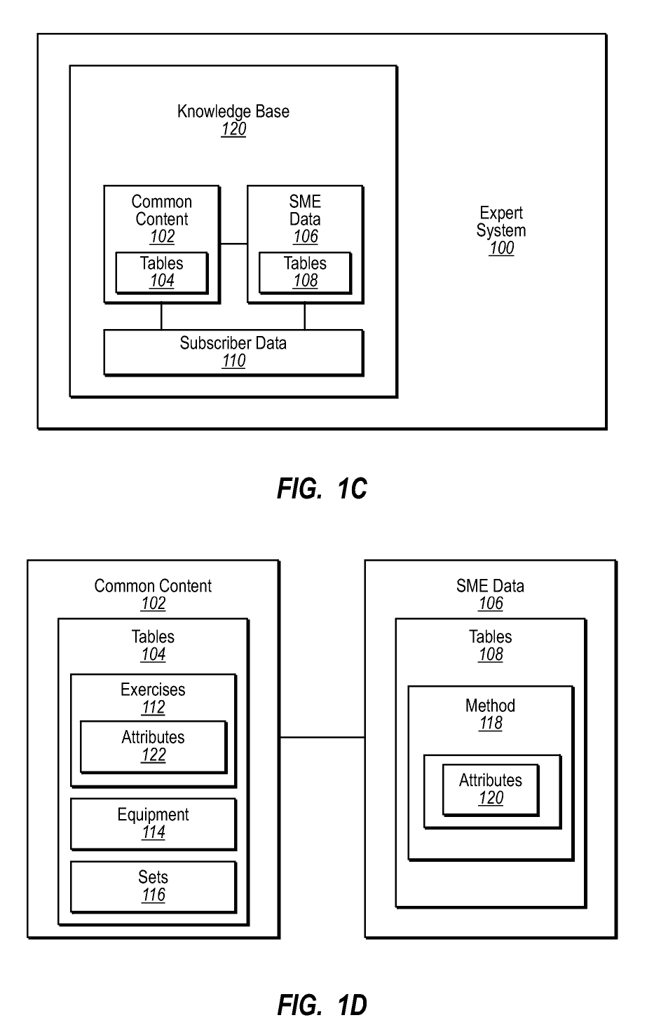

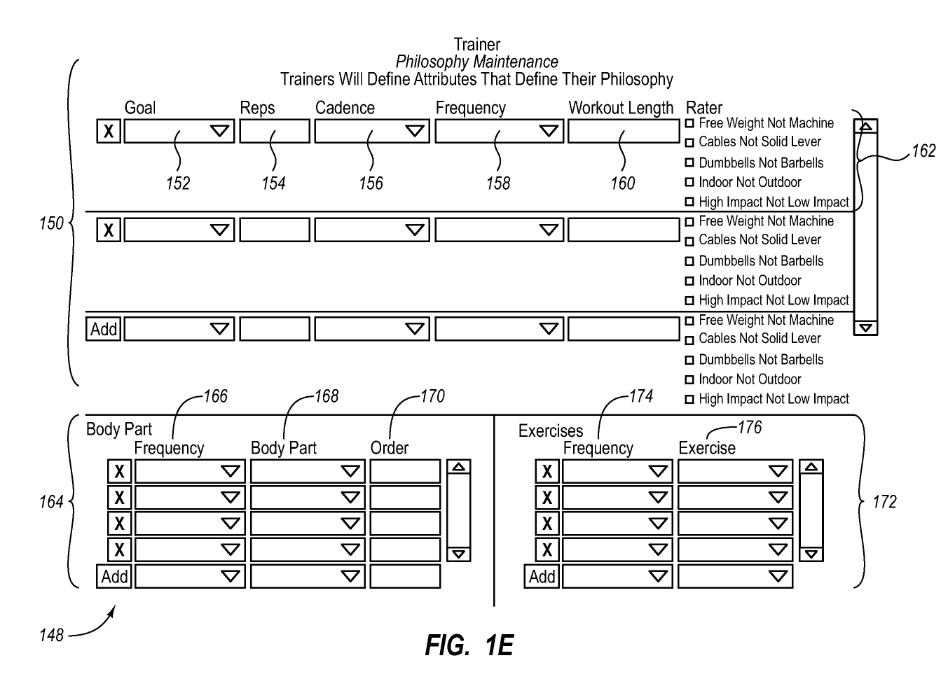

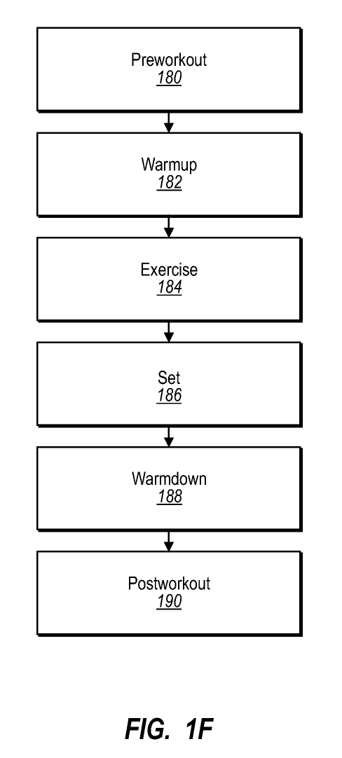

FIG. 1A illustrates one embodiment of a system that includes an expert system. In FIG. 1A, the expert system 10 includes a data model 12 that models a particular subject. The data model 12 often uses various databases including relational databases to store content. The content stored in the data model 12 is generally captured from subject matter experts 20.

In one embodiment, the expert system provides a web interface 18 through which content is captured from the subject matter experts 20. The web interface 18 is often designed to capture information based on the identify of the user. Thus, the interface presented to subject matter experts 20 often differs from the user interface presented to subscribers because the content being captured or presented typically differs.

The expert system 10 captures content from the subject matter experts 20, in one embodiment, by asking for specific content. Some of the content provided by subject matter experts is common content that can be used as building blocks by other subject matter experts. The common content is stored in the data model in a manner that permits it to be accessed through other user interfaces.

For example, if the subject of the expert system 10 is cooking, then the common content may be measurements, cooking utensils, temperature ranges, and other content that is typically used in the context of cooking. A subject matter expert that is providing a recipe may then use these measurements or other common content as the recipe is captured. Thus, the common content serves as building blocks for capturing other content. The common content can facilitate the entry of other more specialized content that is often specific to a particular subject matter expert.

The expert system can be developed with many different subjects in mind and not all can be mentioned. One of skill in the art, with the benefit of the present disclosure, can appreciate the applicability of the present invention to virtually any subject. The resulting media content typically provides a course or a series of instructions, or a routine, and the like or any combination thereof. By way of example and not limitation, exemplary subjects may include instructional subjects (math, reading history, etc.) or any topic found in any instructional curriculum, news (personalized news, contemporary information, etc.), entertainment (music, movies, any entertaining media, etc.), and the like or any combination thereof. Instructional subjects can generate media content that may server, for example, as a class. The “classes” become more advanced or continue to help the subscriber progress over time using content from various instructors (subject matter experts for the class) and various combinations of content based on the goals, status, feedback, etc., of the subscriber. Similarly, news content can be generated that is tailored to a subscriber's interests, favorite reporters (one example of a subject matter experts for news), specific newspapers or other sources of content, etc. One of skill in the art, with the benefit of this disclosure can appreciate the applicability of the invention to virtually any subject and can appreciate that subject matter experts for any given subject can provide content that can be captured and ultimately delivered as individualized media content as described herein.

Thus, some subject matter experts 20 are responsible for maintaining the common content included in the data model 12. Other subject matter experts provide specific methods or philosophies. As mentioned above, the methods or philosophies can be expressed in the manner in which the subject matter expert arranges the common content. Of course, this subject matter expert may also provide content that is not presently found in the data model 12.

The expert system 10 also captures information from subscribers 22. This information is typically crafted in a manner that reflects the subject of the expert system 10. For an exercise program, for example, it may be useful to capture the medical history of the subscriber. For a cooking class, however, the medical history may not be relevant. In any event, the content (also referred to as subscriber attributes) collected from the subscribers 22 provides the expert system 10 with information that can be matched to content that has been provided by the subject matter experts 20. In this manner, specific content can be extracted from the data model 12 that is relevant and applicable to the subscriber.

It is often difficult for a subject matter expert to consider every possible variation that may exist among the attributes of the subscribers. The expert system 10, however, is able to analyze content that has been captured to provided individualized content. For example, once the content is captured from the subject matter experts, (which can be an ongoing process), the expert system 10 can then analyze the content. Because it is often difficult for a subject matter expert in a given subject to contemplate every potential combination of content or instructions, the expert system can analyze the content that has been provided to generate content that fits a particular situation.

For example, the expert system may capture content from a subject matter expert that is related to a particular attribute in a first context. However, the expert system 10 may not capture content that is related to the particular attribute in a second context. The expert system 10 can analyze how the particular attribute impacted the first context and then apply the same philosophy of the subject matter in the second context without requiring additional input from the subject matter expert. This is one example of how the expert system 10 can generate individualized media content using the content provided by the subject matter experts.

After the content is received from the subject matter experts and the subscriber's information or attributes are also captured, the expert system is prepared to identify specific content that is used to generate the media content. The content is typically determined my searching the database of the data model 12 to find content that matches the subscribers 22. In effect, the data model 12 generates the queries and rules needed to content that conforms to a subscriber's goals, attributes, status, preferred subject matter expert, and the like. In one example, the expert system 10 selects all methods (provided by subject matter experts) having attributes that match the subscriber's attributes. The expert system 10 then applies rules to narrow down the list to the content needed for the media content.

After the content needed for an instance of media content is identified, the expert system 10 can provide media mixing and media production 14, which generates the media content 16 by mixing together the content into a media file that can be rendered by a device of the subscriber. The media content 16 is then delivered to the subscriber that requested the media content from the expert system 10.

FIG. 1B illustrates an exemplary method for delivering media content. The expert system begins by capturing 30 content from subject matter experts. As previously described, this can be an ongoing process. As more content is captured, the expert system 10 is able to generate additional media content and to accommodate various situations with more expertise.

Next, the expert system captures 32 subscriber information. This step captures the information needed to query the database in the data model to identify specific content (methods, philosophies, etc.) that is applicable to the subscriber. Thus, determining 34 an instruction sequence includes querying the data model based on the subscriber's attributes. Determining 34 the instruction sequence of content sequence also includes applying rules that enable the content to be narrowed down to a specific content that is to be used for an instance of media content.

Once the content is identified, the expert system 36 generates and delivers an instance of media content to a subscriber. The subscriber can experience the media content on a device (such as an audio and/or video device).

Often, a subscriber can then provide feedback to the expert system. The feedback is an attribute or is a change in the subscriber's attributes. Because the attributes have changed, the next iteration of media content will include new content that may enable the subscriber to progress in the subject of the expert system. In some instances, the expert system 10 also remembers what a subscriber has already experienced to ensure that subsequent instances of media content includes different content. Advantageously, the data model 12 typically includes much more content that can be included in one instance of media content. As a result, the media content experienced by the subscriber can continually vary if the subscriber desires. Alternatively, the subscriber can also listen or otherwise experience media content more than once.

In this manner, the expert system 10 can provide the benefit of a subject matter expert in a given subject to a subscriber in the form of media content. Further, the media content generated by the expert system 10 is not static, but can change and adapt to the subscriber as the subscriber changes or progresses.

Embodiments of the invention further relate to systems and methods for generating individualized media content that can be navigated by a subscriber. Navigable media content provides a subscriber with media content that can be further customized by user or that can be readily adapted to the usage or desired usage of the subscriber. Navigable media content, in one embodiment, can be generated in a way that enables a subscriber to play specific portions of the media content at will. In this manner, the media content can be adapted and used according to the subscriber's wishes.

Like a personal trainer that can adapt exercise sessions to the performance of a person, embodiments of the invention can produce media content that adapts to the performance of the subscriber. For example, a personal trainer may be able to have a subscriber repeat a particular portion of an exercise routine or show the subscriber how an exercise is to be performed. Embodiments of the invention enable these aspects and other aspects of an exercise routine to be included in personalized media content. Further, some of the media content can be made optional according to the navigable aspects of the media content. As a result, not only does the subscriber receive individualized media content that contains the expertise of a personal trainer, but the subscriber can further adapt the media content to the subscriber's own pace and convenience.

Individualized media content is typically created from a database, referred to herein as a knowledge base, that stores and/or incorporates content from different sources such as subject matter experts. The knowledge base can be adapted to any subject or field. For example, the knowledge base may focus on fitness or exercise, a particular field of study, travel, or any other activity or endeavor. Once the content from the various sources has been incorporated into the knowledge base, the knowledge base can be accessed based on certain parameters, such as a subscriber's attributes, to identify specific instances of the content, such as media clips. The media clips selected or identified from the knowledge base are aggregated and mixed together to generate individualized media content.

Typically, the individualized media content is a file that represents a session for the subject of the knowledge base. In the case of exercise, for example, the media content may represent an exercise routine. In the case of travel, the media content may represent a tour through a city or place of interest. Generally, the session embodied in the media content relates to the subject of the knowledge base and includes content provided by or extracted from the repository of content provided by the various sources and included in the knowledge base.

The knowledge base can be used to generate multiple instances of the individualized media content. An expert system that operates the knowledge base can monitor the progress of the subscriber (e.g., based on feedback from the subscriber or by analyzing how the subscriber's attributes change over time). This feedback is taken into account when generating subsequent instances of individualized media content. Further, the content that is used to generate an instance of the media content is typically larger than what can be included in a single instance of the media content. As a result, an expert system can draw from different aspects of the content to generate varying instances of the media content. In the context of exercise, for example, an expert system may use content from a particular subject matter expert on a particular exercise device. Another instance of the media content may include an exercise routine that uses the same subject matter expert (or a different subject matter expert) on a different exercise device. Thus, the individualized media content can vary in multiple ways that may include, but are not limited to, selection of subject matter experts, exercise, and the like or any combination thereof. Further, the content from the knowledge base that is available for use in the media content often changes for several reasons. For instance, new content may be added to the knowledge base and made available for use in the media content. Also, the changing attributes of the subscriber may make cause additional content to be available. Thus, the content from the knowledge base used to generate individualized media content can change as a subscriber improves, sets new goals, etc.

Embodiments of the invention are discussed below with reference to the subject of exercise or fitness. In the context of this subject, trainers are examples of subject matter experts (SMEs) that can provide content that can be modeled and incorporated into the knowledge base. One of skill in the art that the knowledge base can be adapted to other subjects and that appropriate subject matter experts can contribute content relevant to their subject.

As a result, embodiments of the invention can generate individualized media content for a wide variety of different subjects. Exemplary subjects include, but are not limited to, instructional or educational courses or content, sports activities, art, travel, entertainment, and the like or any combination thereof. The subject matter experts are those that have expertise or that have knowledge related to a given subject. For example, a professor or teacher may be a subject matter expert for an educational course, while a travel agent may be a subject matter expert for travel. The subject matter experts can be identified based on the subject of the content included in the knowledge base.

The knowledge base includes content in various forms and formats from multiple users or entities. One of the users or category of users that provides content that is incorporated into the knowledge base, as previously suggested, is a subject matter expert (SME). Some of the SMEs provide content that serves as building blocks, while other SMEs provide content by identifying specific combinations of the building blocks or by providing additional content to the knowledge base. In the context of exercise, for example, the content that serves as building blocks may include generating tables in the knowledge base that define exercise equipment or that define exercises, and the like. Some of the SMEs can then provide content that may incorporate the defined exercise equipment and/or defined exercises into a routine in a manner that expresses the philosophies of the SMEs. For example, one SME may define a treadmill along with the treadmill's settings (maximum speed, maximum incline, etc.). Another SME may use this type of information for an exercise that requires use of the treadmill for a certain amount of time at a certain speed and incline. In this manner, certain SMEs can use the common content as building blocks to generate content that reflects their own expertise and exercise philosophy. Similarly, SMEs in other subjects can provide similar types of content that can be used in a similar manner to generate personalized media content and to serialize the media content with successive instances that account for user performance.

Further, the content provided or organized by the SMEs can be analyzed to identify patterns or philosophies that can be used to generate the individualized media content. This enables an SME to provide information in a first context, for example, that the system can adapt for use in a second context without requiring the SME to provide content for each potential situation or context. For example, the expert system may analyze how the SME handles a medical history with respect to a first exercise and then apply the philosophy to a second exercise or situation. The analysis of content provided by SMEs is further described in U.S. patent application Ser. No. 11/425,372, filed Jun. 20, 2006, which is incorporated herein by reference in its entirety.

Media content, in one embodiment, is an individualized media file that typically can include audio and/or video content. Images may also be included in the media file. Typically the media content includes one or more media clips, each of which may include audio and/or video content, that are selected according to some criteria and then mixed, resulting a personalized media content.

The content received from the subject matter experts is incorporated into the media clips such that, when the individualized media content is delivered, it includes specifically selected content from subject matter experts. Advantageously, subscribers of the media content can receive the benefit of content provided by one or more subject matter experts in any given media content. In this manner, each subscriber can receive individualized media content that reflects the expertise of at least one SME.

A subscriber that accesses and uses the system described herein ultimately receives individualized media content. When the subject is exercise, the media content delivered to a subscriber may be a workout routine that includes content from one or more subject matter experts. Embodiments of the invention can therefore deliver the expertise of a subject matter expert in the form of personalized media content, which may include audio and/or video content.

FIG. 1C illustrates one embodiment of an expert system 100 that includes a knowledge base 120. The knowledge base 120 is, in one embodiment, a relational database. The expert system 100 can perform queries and execute rules processing to produce output that conforms to the goals, attributes, and/or status of a subscriber. In one example, the output is individualized media content that can be transmitted to a subscriber and performed on a media device, such as a personal audio/video player, computer, cellular telephone, and the like or any combination thereof.

The knowledge base 120 stores various types of content that includes, in this example, common content 102, SME data 106, and subscriber data 110, each of which can be interrelated. The common content 102 is one embodiment of the building blocks of the knowledge base 120 that is typically provided by a first SME or by a group of SMEs that are responsible for generating, updating, maintaining, etc., the common content 102.

The common content 102 includes tables 104 used to store and/or reference various kinds of content in various forms including media clips. Exercises, for example, are defined in the common content 102 in terms of name, description, body part (chest, back, shoulder, biceps, triceps, etc.), equipment, progression (resistance, volume, distance, rate, etc.), and/or clip intro (recorded media). The common content 102 may also include tables related to exercise equipment, age group, cadence, endurance, experience level, frequency, goal, medical event, and the like or any combination thereof.

The SME tables 108 are similar to the tables 104. In one embodiment, the SME tables 108 are used to define methods, which involve the selection of an exercise from the common content 104 and the providing of attributes such as frequency, cadence, reps, sets, rests, age group, medical history, experience level, endurance level, fitness level, availability, and the like or any combination thereof. The methods generated from input from an SME can be stored in the knowledge base 120.

The knowledge base 120 also includes subscriber data 110. The attributes of the each subscriber can include name, gender, height, age group, goal, email, equipment available, medical history, weight, and the like or any combination thereof. Some of the subscriber attributes are variable. Age, weight, goal, email, equipment available, and the like are examples of attributes that may change or that may be changed by a subscriber.

For example, a subscriber may purchase new equipment. By providing this information to the expert system 100, content that was previously not applicable to the subscriber becomes available for use in the generation of the media content. If the subscriber is injured, this information can also be updated in the medical history of the user. Similarly, the subset of content that is selected and used to generate the subscriber's media content changes.

Using the knowledge base 120, the expert system 100 can query for specific content, analyzed the content returned by the query, and ultimately generate individualized media content. The media content can be an audio file, a video file, and audio/video file and the like. The media content may also include navigable elements such as marks that enable a user to quickly access specific locations in the media content. The media content may also include other navigable elements such as a user interface. The user interface can be displayed visually on a screen of a device and/or played audibly on a device. The device typically has an input mechanism (buttons, knobs, touch screen, soft keys, and the like) that enable a user to interact with the media content. By including navigable elements in the media content as described below, a user can adapt the already individualized media content further to accommodate the wishes of the user. For example, the navigable elements may enable a user to repeat specific portions of the media content, seek or skip specific portions of the media content, bookmark a portion of the media content, and the like or any combination thereof.

As previously mentioned, the knowledge base includes much data in addition to media clips that can be mixed together to form individualized media content. FIG. 1D illustrates examples of the content that may be included in a knowledge base. FIG. 1D is described in the context of a knowledge base used for exercise and one of skill in the art, with the benefit of the present disclosure, can appreciate that the knowledge base and its content can be adapted to other subjects as well.

The common content 102 can be maintained by one type of subject matter expert. The common content 102 is often established or created by normalizing the common characteristics of the philosophy and methods of other subject matter experts. Thus, the common content 102 may be pre-recorded or stored, which enables the common content 102 to be used as building blocks by other subject matter experts. The common content 102 can be updated over time or augmented with additional information.

The common content 102 is often stored as tables 104 in a relational database. In this example, the common content 102 includes, by way of example and not limitation, exercise tables 112, equipment tables 114, sets tables 116. Other tables can be used for the media clips, age groups, equipment availability, body part, cadence, endurance, experience levels, fitness levels, frequency, goals, medical events, and the like or any combination thereof.

Each of the tables 104 is typically associated with multiple attributes. For example, the attributes 122 of the exercises in the exercise tables 112 may include, but are not limited to, name and description, body part (chest, back, shoulder, biceps, triceps, abdominals, legs, calves, forearms, etc.), equipment, progression (resistance, volume, distance, rate, and media clip introduction, and the like.

In some instances, the attributes of one table may reference another table. For example, the equipment attribute of the exercise tables 112 may reference the equipment tables 114.

The attributes of the sets tables 116 may include cadence (number of seconds for lifting/lowering), reps (number), and a set of media clips (recorded media). The attributes of the equipment tables 114 may include name, description, and categorizations. Exemplary categorizations (yes/no) may include: free weights not machine; cables not solid lever; indoor not outdoor; high impact not low impact; and the like or any combination thereof.

The common content 102 therefore includes a substantial amount of information that is used in the generation of individualized media content.

The SME data 106 can be similarly arranged using tables in the knowledge base. In this case, however, the SME may be using information from the common content portion of the knowledge base. In the context of exercise, an SME may define a method 118 that is stored as a table. When a method 118 is created, the SME may select an exercise from the exercise tables 112, for example. Once the exercise is selected, the SME may then provide attributes 120 that reflect the expertise and philosophy of the SME. Exemplary attributes 120 may include, by way of example only, frequency (days per week), cadence (number of second lifting/lowering), reps (number), sets (number), and rest (seconds). Each of these attributes 120 may be selected from corresponding tables in the common content. However, the method 118 is a customized according to the SME that creates the method 118.

Other attributes 120 that may be associated with a method 118 may include an age group, a goal (fat loss, fitness, build muscle, stress reduction, medical, body shaping, etc.), medical history (high blood pressure, diabetes, arthritis, high cholesterol, joint replacement, pregnancy, etc.), experience level, endurance level (in terms of time), availability, and the like or any combination thereof.

An SME typically has access to his or her methods and is able to perform various operations (add, delete, edit, etc.) on certain methods. In one example, the goal of an SME can begin by determining a goal. For each goal, the tables 108 can be used to store reps, cadence, frequency, and workout length. Each goal may also be associated with other tables or lists. For example, each goal may be associated with a body parts table (including frequency and ordering) and with an exercises table (including frequency).

The ability to maintain a philosophy, for example, is illustrated in FIG. 1E, which illustrates a user interface by which an SME can maintain or define attributes that define his or her philosophy. The user interface 148 enables an SME to define goals 150. Each goal 152, which can be selected using a drop down menu that is populated from the knowledge base in one embodiment, can be defined in terms of reps 154, cadence 156, frequency 158, and workout length 160. Rules 162 can also be established for each goal 152.

The user interface 148 also presents a body part list 164 that can be associated with each goal. The frequency 166, body part 168 and order 170 can be set. The user interface 148 also presents an exercise list 172 that can be associated with each goal. In this example, the exercise list 172 enables the SME to set a frequency and a specific exercise 176 for each goal.

The knowledge base illustrated in FIG. 1C stores information as described above using multiple tables. Each table may include information that is provided by a subject matter expert, by the subscriber, or by another person or entity. The expert system 100 also establishes relationships that enable the tables to be linked together and accessed for information. The following paragraph illustrates examples of tables 104, 108, and other subscriber tables and their relationships.

For example, an age group table lists all possible age groups used in the expert system and is used to match a subscriber with a particular method. As previously described, an SME can often set a particular age group for a given method. This enables the age of the subscriber to be matched to appropriate exercises that may be included in the individualized media content. An availability table may list all possible exercise availability options used to identify what a subscriber's time availability is and may be used to match the subscriber to methods. A body part table lists all body parts used to identify exercise localizations and may be used in an exercise table and an SME's philosophy attributes to match exercises with the SME's methodology. A cadence table lists all speed or cadence options to define how exercise counting is to be performed and is issued in method and set tables. An endurance table lists endurance designations that are used in the subscriber's status table, thereby identifying how long the subscriber is able to exercise. An equipment table lists all possible equipment used in exercises and can be used in conjunction with a subscriber's equipment availability designations. An experience table lists experience level designations and can be used to match a subscriber's stated experience and specific exercise requirements in a method table. A fitness level table lists all possible fitness levels and is used to match the subscriber's stated fitness level with specific fitness exercise requirements in the method tables. The frequency table may list all possible workout frequencies used by SME's in defining an exercise. A goal table lists all possible goals that a user can select and are used to match against trainer philosophies. A medical event table lists all possible medical events a subscriber can select and is used to match against trainer philosophies. An exercise table lists all possible exercises used in the system and is used by SME's to define their philosophies. A scriptlet table maintains all media clips (such as physical mp3 files). This table identifies the location, type, name, etc., of each media clip. The set table is used to identify which media clip to use for counting through an exercise, given it's cadence and reps.

Other tables are also present in the knowledge base. Subscriber tables that store subscriber attributes are kept and often used to identify exercises or other content that may be used when generating individualized media content. A workout table may be calculated and represents the result of the process of generating individualized media content. The workout table typically determines what the sequence of steps are for a given workout. A workout exercise table corresponds to the workout table and contains the actual list of steps.

The following discussion illustrates the use of the expert system to generate individualized media content. FIG. 1F illustrates an example of a method performed by the expert system (callable via a web application in one embodiment) to generate a custom workout. Generally, the SME defined methods are selected from the knowledge base according to how subscriber attributes match the method attributes. The list of returned methods can then be organized according to order, trainer philosophy filtering, and the like.

Each workout typically has a series of steps and a workout table is populated such that specific media clips can be identified as illustrated in FIG. 1F. First, a preworkout 180 is identified by querying a trainer from the subscriber. The trainer table in the knowledge base often identifies a preworkout media clip. Next, a query is performed for a warmup 182 on a warm table using the primary goal obtained from the goal table of the subscriber.

Next, the attributes of the method tables (and other tables in one embodiment) are queried by matching attributes of the subscriber against attributes of the methods. This query often results in a list of exercises 184 (or a list of methods). Philosophy information in the SME tables are then used to select the number and order of exercises from the list of methods. For each exercise, a media clip is inserted along with the cadence and reps metrics or media clips. Rules can be used to filter the list of exercises down to an appropriate workout.

Next, the set 186 table is queried, using cadence and reps from the current exercise, in order to identify the appropriate counting media clip, which is then inserted into the workout table. The warm table may then be accessed for the warmdown 188 using the primary goal from the subscriber's goal table. Finally, a postworkout 190 is identified from a query of the SME table, which includes a postworkout media clip. The media clips identified in the above process are organized in a workout table. Often, the media clips may be identified by an identifier that points to the actual location of each media clip.

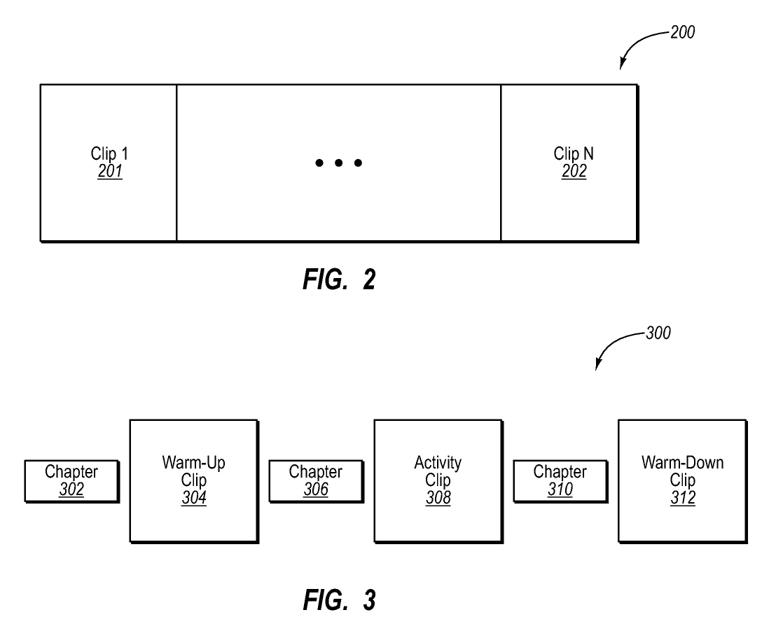

FIG. 2 illustrates one embodiment of individualized media content that is generated from the knowledge base. When a request is made for individualized media content, the knowledge base is searched for content based at least on the subscriber's attributes as discussed above. The resulting content is then filtered down using rules, for example, to the content needed for at least one instance of individualized media content. In one example, the result of the filtering process is a series of identifiers where each identifier corresponds to a media clip. The series of identifiers can be organized using a template.

The media clips identified by the list of identifiers are then mixed to generate the media content 200. Thus, the media content includes a plurality of media clips, represented by the media clip 201 and the clip 202. Often, a template is used to generate or identify the clips that should be included in an instance of individualized media content. When the media content is an audio file, playing the media file takes the subscriber through the workout routine from warm-up to warm-down. the various clips may be used to insert silences, rest periods, or provide other instructions from an SME.

The media clips used in the generation of the media content 200 vary. Some of the clips may be automatically selected by the expert system. For example, there are media clips that may be inserted as a spacer such that a subscriber has time to move from one exercise device to another exercise device. Some of the media clips are used to provide instructions to the subscriber, provide cadence, identify repetitions, and the like. The specific clips included in the media content 200 may depend on the subject of the knowledge base, the attributes of the subscriber, and the like. For example, an older subscriber may be given more time to move from one exercise device to another exercise device or may be given clips that represent a longer rest period.

Embodiments of the invention also provide for making the media content navigable. FIG. 3 illustrates one embodiment of a media clip 300 that is navigable. In this example, The media content 300 includes chapter marks 302, 306, and 310 in this example. The chapter marks 302, 306, and 310 may be clips in themselves. Alternatively, the marks 302, 206, and 310 are formatting that is added to the media content 300 to identify specific locations in the media content 300.

The use of the marks can vary. For example, selecting the next button on a media player may direct the device to the next chapter mark. In this case, the subscriber could potentially skip the warm-up clip 304 and begin the activity clip 308 immediately without having to wait for the warm-up clip 304 to be played. In addition, the previous button on a media player can be used to start a particular clip from the beginning. In the case where an activity clip 308 corresponds to an exercise, the mark 306 can enable the device to repeat or start over at the point in the media content 300 associated with the mark 306.

Further, the marks can be used within a particular clip and can optionally be set automatically or with subscriber input. Typically, marks are set at each logical separation of the exercise routine. A mark is set for the warm-up, one at each activity, and one at the warm-down. However, a mark can be set at any portion within a particular clip or at the beginning of any clip. Also, marks can be used to identify particular portions of a clip. For example, an exercise routine may include a clip that includes video, audio, text, etc. The mark can be used to restart a particular portion of the clip. For example, the activity clip 308 may provide instructions relating to using a stair machine. The activity clip 308 may also include a video illustrating use of the stair machine. If a subscriber begins this clip 308, the mark, such as the mark 306, or multiple marks can be used to start the video over, start the audio over, start the instructional video, and the like or any combination thereof.

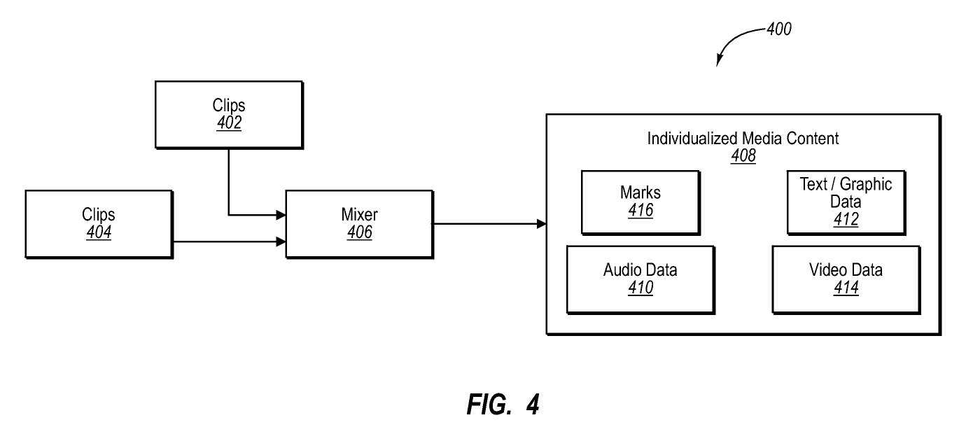

FIG. 4 is a block diagram illustrating the process of generating individualized media content that includes marks or other navigable elements. The mixer 406 typically begins the process of generating the individualized media content after the clips needed for inclusion in the media content 400 have been identified. In some instances, the mixer 406 has modules that enable it to include certain clips that are not necessarily dependent on subscriber attributes. For example, rest clips and the like can be automatically included and may be predetermined by the template used for the media content.

In FIG. 4, the clips 402 and 404 mixed by the mixer 406 may come from different sources. The mixing of clips can occur at a server computer, at a client computer, or at any computing device. When mixed at a server, the individualized media content is then transmitted to the subscriber. For example, the clip 404 may be background music from the subscriber's own library that is uploaded for mixing by the mixer 406.

During the mixing process, the mixer 406 analyzes certain attributes of the clips 402 and 406, such as volume, and then normalized the volume as the clips 402 and 404 from different sources are mixed. In another embodiment, the clips 402 often include voice instruction. The mixer 406 can identify these instances and adjust the volume of other clips accordingly. For example, the volume of the background music may be reduced during voice instruction or for other reasons.

The mixer 400 produces the individualized media content 400. In this example, the media content 400 may include audio data 410 (voice instructions on how to use the equipment, how many repetitions to perform, what weight to set, what speed to set, how long to exercise, cadence counts, encouragement, and the like), video data 414 (a video for viewing pleasure while exercising such as a music video to the background music, a video illustrating use of exercise equipment, a pacing video so that the subscriber can mimic or copy the trainer in the video, etc.), or text/graphic data 412. The text/graphic data 412 can be displayed to the user for example and may indicate, by way of example, calories burned, time remaining, or present a menu that can be navigated by the subscriber via the input mechanisms of the subscriber's device. In one embodiment, the menu corresponds to the marks 416 such that a user can navigate to portions of the media content 400 using the text menu or other user interface. In one embodiment, the mark may include content that is displayed in the menu. In one embodiment, the contents of the menu can change from one mark to the next.

The marks 416 in the individualized media content 400 can be inserted by the mixer 406 or be an integral part of the clips 402 or 404. The mixer 406 places the marks such that the media content can be navigated by the device (such as an audio and/or video player) at the direction of the subscriber.

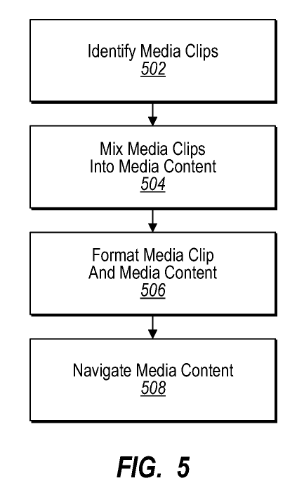

FIG. 5 is a flow diagram illustrating an exemplary method for generating media content with navigable elements. The process begins by identifying 502 clips and/or other content for inclusion in an instance of media content. Identifying the clips or other content often includes a query of the knowledge base using the subscriber's attributes to identify applicable content. The content returned in the query can then be distilled down to the content needed for the media content. This can be done using a template that identifies which type of clips are needed. In some instances, a template may already include certain clip references (such as rest clips), and the like. However, the length and other aspects of these clips in the template can be adjusted as necessary.

After the media clips are identified, a mixer mixes 504 the media content to generate the media content. This can include volume regulation that is achieved in one embodiment, by normalizing the volume of audio in each clip and then combining the clips such that abrupt changes in volume are not experienced.

Next, the media content is formatted 506 with marks. The inclusion of marks or other navigable elements in the media content can be achieved after the media content is mixed or while the media content is mixed. Formatting the media content with marks enables a subscriber to select, repeat, skip, etc., specific portions of the media content or otherwise navigate the media content. In some instances, the media content may include a link to another source of data that can be accessed over a network if the subscriber's device is network enabled.

After the media content is delivered or available to the subscriber, the subscriber can navigate 508 the media content. The navigation may include repeating a particular portion of the media content, playing a specific portion of audio or data included in the media content. The ability of a subscriber to navigate the media content is typically achieved by receiving input through a user interface of the subscriber's device. The marks may also enable a device to “remember” where a subscriber is in a particular routine and to resume from that point or from any other point at a later time. A user is not required to start from the beginning each time the media content is used.

In general, the navigable marks included in the media content make the media content navigable in a variety of different ways as discussed herein. Advantageously, the navigable elements enable the user to adapt use of the media content to the subscriber's wishes, thereby providing an additional layer of individualization.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a system In a system including a subscriber that has access to a knowledge base for a subject, a method for generating navigable media content, the method comprising:
identifying one or more clips from a knowledge base for inclusion in an instance of media content;
mixing the one or more clips to produce the media content; and
formatting media content to include one or more marks, the one or more marks used to navigate the media content.

2. A method as defined in claim 1, wherein identifying one or more clips from a knowledge base further comprises performing a query on the knowledge base for content based on attributes of a subscriber, wherein at least one of the attributes is variable such that different content is returned from the knowledge base for a subsequent query.

3. A method as defined in claim 2, wherein identifying one or more clips from a knowledge base further comprises distilling results of the query to specific content for inclusion in the media content.

4. A method as defined in claim 1, wherein mixing the one or more clips further comprises mixing the one or more clips to normalize a volume of each of the one or more clips.

5. A method as defined in claim 1, wherein mixing the one or more clips further comprises mixing the one or more clips from one or more sources, wherein at least one source is the knowledge base and wherein at least another source is a library of the subscriber, wherein a clip from the library of the subscriber comprises background music for the media content.

6. A method as defined in claim 1, wherein formatting the media content further comprises placing a mark at a beginning of at least one of the one or more clips mixed into the media content.

7. A method as defined in claim 1, wherein formatting the media content further comprises inserting a mark for at least one of a particular video included in the media content, a particular audio included in the media content, or a particular text included in the media content.

8. A method as defined in claim 1, wherein formatting the media content further comprises including a navigable menu that can be displayed on a device of the subscriber, wherein the navigable menu enables the subscriber to perform at least one of:
skipping a portion of the media content;
playing a video embedded in the media content;
repeating a portion of the media content;
randomizing portions of the media content; or
bookmarking a location of the media content.

9. A method as defined in claim 1, further comprising:
receiving input from the subscriber at the device; and
navigating the media content based on the input received from the subscriber.

10. A method as defined in claim 1, wherein the media content comprises one of:
an audio file;
a video file; or
a multimedia file including audio content, video content, text content, and graphic content.

11. A computer readable medium having computer executable instructions for performing the method of claim 1.

12. In a system including a knowledge base that stores content for a subject, a method for generating navigable content for a subscriber from the knowledge base, the method comprising:
mixing an instance of media content from media clips that have been identified from a knowledge base according to at least attributes of a subscriber;
adding one or more navigable elements to the media content, wherein the navigable elements are embedded in the media content and enable the subscriber to perform the media content in a manner determined by the subscriber; and
transmitting the navigable media content to a subscriber.

13. A method as defined in claim 12, wherein the media clips originate from one or more sources, mixing an instance of media content further comprises normalizing a volume of each of the media clips.

14. A method as defined in claim 13, wherein the one or more sources include one or more of:
a library of media clips in the knowledge base;
a library of the subscriber located on a device of the subscriber;
an online library.

15. A method as defined in claim 12, wherein mixing an instance of media content from media clips further comprises adding predetermined clips to the media content, the predetermined clips including rest clips.

16. A method as defined in claim 12, wherein mixing an instance of media content further comprises adding a navigable element at a beginning of at least one of the media clips.

17. A method as defined in claim 12, wherein the navigable elements comprise:
a mark identifying a location in the media content to begin performing the media content; or
a menu that presents an interface that enables the subscriber to navigate to specific portions of the media content.

18. A method as defined in claim 12, wherein the navigable elements enable the subscriber to perform at least one of:
skipping a portion of the media content;
playing a video embedded in the media content;
repeating a portion of the media content;
randomizing portions of the media content; or
bookmarking a location of the media content.

19. A method as defined in claim 12, further comprising:
receiving input from the subscriber, the input acting on at least one navigable element; and
navigating the media content according to the selected navigable element and the input received from the subscriber.

20. A method as defined in claim 12, wherein adding one or more navigating elements to the media content further comprises one of:
formatting the media content with the navigable elements after mixing the media clips; or
including the navigable elements as the media content is mixed from the media clips.

21. A method as defined in claim 12, wherein mixing an instance of media content from media clips further comprises:
performing a query on the knowledge base using the attributes of the subscriber to identify a subset of content;
distilling the subset of content using rules to identify specific content for inclusion in the media content; and
identifying the media clips associated with the specific content, wherein the media clips are organized according to a particular template.

22. A computer readable medium having computer executable instructions for performing the method of claim 12.

23. A method for generating individualized media content for a subscriber that adapts to the subscriber and that reflects the expertise of a subject matter expert, the method comprising:
capturing content from one or more subject matter experts in an expert system, wherein the content is stored in a relational database;
capturing attributes from one or more subscribers;
querying the expert system based on the attributes a particular subscriber to identify content that relates to the particular subscriber; and
producing an instance of individualized media content for the particular subscriber, wherein the individualized media content includes the content identified by the query of the expert system.
